(19) United States
(12) Patent Application Publication
(10) Pub. No.: US 2009/0321001 A1
(43) Pub. Date: Dec. 31, 2009

(54) ONE-PASS DIRECT DOUBLE LAMINATION APPARATUS AND PROCESS

(75) Inventors: James E. Dye, Wooster, OH (US); Kenneth W. Chaloupek, Medina, OH (US)

Correspondence Address: Joseph J. Crimaldi;Roetzel & Andress, 222 S. Main St., Akron, OH, 44308, US

(73) Assignee: SEAMAN CORPORATION, Wooster, OH (US)

(21) Appl. No.: 12/146,695

(22) Filed: Jun. 26, 2008

(51) Int. Cl. B32B 37/02; B32B 38/06

(52) U.S. Cl. 156/220; 156/498; 156/306.6

(57) ABSTRACT

A method and apparatus for forming a laminate of calendered films in one pass including feeding means for feeding a base fabric; heating means for preheating the fabric to raise the temperature of the fabric and remove residual moisture; a first calendering means for forming a calendered film and applying said film to the base fabric; roller means for joining the first calendered film to said base fabric; a second calendering means located subsequent to and spaced apart from the first calendering means for forming a second calendered film and applying the second film to the uncoated side of the base fabric; roller means for joining the second calendered film to said base fabric to form the double laminated film; means for cooling the double laminated film; and means for collecting the laminated film.

### BACKGROUND OF THE INVENTION

The present invention is directed to a one-pass direct double lamination apparatus and process in which calendered polymeric films are laminated on each side of a base support web to make fabrics coated on both sides for use, e.g., for tents, tarps, fuel tanks, sign facing or billboards, inflatable boat fabric, architectural fabrics, single ply roofing membranes, geomembranes, and the like.

Weatherable outdoor fabrics have many uses in temporary, permanent or semipermanent structures. For example, such fabrics form a flexible covering for tents and other structures used for weddings, festivals and other special events. These fabrics may be used in other situations, however, such as for inflatable tents or as covering for awnings and canopies. A fabric needs specific qualities to be useful in such applications. In particular, many modern architectural designs incorporate curved lines in fabric coverings, and such fabrics should be capable of being dimensionally stable along these curved lines.

Tents and other structures used for special events typically include some rigid elements onto which a flexible fabric is draped or connected. The fabric protects the tent's occupants from the weather. To accomplish this task, the fabric typically is relatively lightweight for ease of erection and durable to withstand the elements. The fabric is preferably waterproof to provide shelter from rain or snow and is also substantially opaque to provide protection from the sun. The fabric should be aesthetically pleasing as well.

In addition to protection from environmental conditions, the fabric often adds to the structural integrity of the tent. Many times tensions within the fabric create forces which aid in holding the rigid elements of the tent in proper place. These tensions, as well as other external forces, place stress on the fabric in many directions. The stress caused by such forces tends to instigate fabric deterioration and fatigue, preventing the fabric from performing its intended duties. The stress, in combination with the fabric fatigue and other external forces, may effect tearing of the fabric rendering it useless.

Conventional fabrics used in tents and other similar structures comprise traditional woven or knitted fabrics which are laminated, coated, or specially finished to instill the desired qualities. Traditionally, a heavy duck fabric or canvas with a waterproofing finish has been used in tent construction. These fabrics are strong and durable and can withstand the forces placed on them while in use. These fabrics, however, are expensive to make, prone to rotting and, because of their weight, are often difficult to manipulate.

In recent years, laminated knitted and woven fabrics have been proposed as tent-making fabrics. These fabrics include a lightweight woven scrim layer such as a polyester fabric with a layer of polymer coating material applied to both sides to add cohesion, opaqueness, and water repellency. These fabrics are inexpensive and lightweight enough for easy maneuverability, but these fabrics also have a tendency to tear under the stress placed on them in the tent environment. The warp and weft yarns of the woven scrim form 90° angles. The fabric possesses high strength in the direction of the yarns. However, fabrics used in tent construction often undergo stresses in the bias directions between the 90° angles formed by the yarn such as adjacent a grommet or tent pole. Similarly, in architectural designs requiring curved lines, it is difficult to align warp or weft directions with the curved lines, thus sacrificing dimensional stability. Further, even in the directions of the yarns, the crimp of the yarns caused by weaving or interlacing the yarns together lessens the dimensional stability of the fabric.

Making webs coated on both sides of the web are known, but usually these are achieved using, for example, roll coating or other coating processes or by using adhesive bonding processes and preformed sheets. Fabrics for architectural applications such as tents are achieved in multi-step coating processes is which the fabric is coated on one side with the polymeric coating, the fabric is gathered, and then the second coating is applied to the fabric.

In a wet lamination process, for example, adhesion is achieved by coating a solvent, plastisol, or waterborne adhesive to one or both sides of at least one of the webs followed by combining these webs in a pressurized nip between two lamination rollers while the adhesive solvent, plasticizer, or water is still present. Drying of the web(s) is achieved after lamination of the webs by heating means or in particular cases by absorption of water to the laminated paper. The wet lamination process is well known as an effective method to laminate paper to films. An example is U.S. Pat. No. 5,037,700 discloses flexible laminates for packaging and their preparation, wherein a first lamina is coated with a room temperature curable adhesive, heating the lamina to remove water and solvent, superimposing a second lamina over the coated surface of the first lamina and roller nipping the laminate at a temperature from 25 to 150° C., thereby bonding the laminate.

U.S. Patent Publication No. 2006/0194994 to Niemoller et al discloses a roll-to-roll lamination process for flexible webs including coating of at least one side of a first flexible web with a film forming adhesive and contacting the adhesive side(s) of the first flexible web to at least one of a second flexible web and a third flexible web on a transport roller while the combined webs are touching the transport roller from one side on a length of more than 5 mm without being further pressurized.

U.S. Pat. No. 4,889,073 to Meinander teaches a method and apparatus for two-sided coating of a moving web, specifically a paper web, and smoothing the coating, in which the direction of movement of the web is substantially upwards and the nip is mounted at a short distance from the coating channel outlets.

U.S. Patent Publication No. 2005/0008785 to Kytonen et al teaches the application of a coating slip to a first surface of a moving paper or board web using a gravity-based application method, the web's direction of travel is turned by 120-200°, then a coating slip is applied to a second surface of the web using a gravity-based application method, and both sides of the web are dried.

U.S. Pat. No. 5,296,257 to Knopp et al teaches an apparatus for coating a paper or cardboard web on both sides, having two press rollers which are disposed side by side and between which there is configured a nip through which the web is guided, characterized in that there is an application and metering system for the separate determination of the quantity of coating material applied to the web and for continuous determination of the quantity of coating material applied to the press rollers.

U.S. Pat. No. 5,597,615 to Tsunoda et al teaches the use of an extrusion coating head which is disposed between a drier which performs a non-contact drying operation and a support roll located at the upstream side of and nearest to the drier and the running web is coated with the coating liquid by the extrusion-type coating head, and then dried through the non-contact drying process.

When laminated films, such as polyvinyl chloride (PVC) films, which are intended to have a layer on each side of the reinforcing web, are desired, they are usually achieved by either joining a formed PVC film with a reinforcing web or calendering the laminate to put the coating on both sides of the reinforcing web. Examples of this are U.S. Pat. Nos. 4,666,761 to Stamper et al and 5,399,419 to Porter et al. Alternatively, the composite films could be made by laminating one layer to a base web, cooling and collecting the web having a coating on one side, and then laminating a second layer to the uncoated side. But, in doing so, there is the difficulty is that the heating of the coated web can disrupt the bonding of the already laminated side of the composite web.

### SUMMARY OF THE INVENTION

The present invention is to a method and apparatus for forming a laminate of calendered films in one pass including feeding means for feeding a base fabric; heating means for preheating the fabric to raise the temperature of the fabric and remove residual moisture; a first calendering means for forming a calendered film and applying said film to the base fabric; roller means for joining the first calendered film to said base fabric; a second calendering means located subsequent to and spaced apart from the first calendering means for forming a second calendered film and applying the second film to the uncoated side of the base fabric; roller means for joining the second calendered film to said base fabric to form the double laminated film; means for cooling the double laminated film; and means for collecting the laminated film.

The process and apparatus of the present invention results in a laminate with improved adhesion as compared to a laminate made by passing a base fabric twice through a calender laminating apparatus so that the calendered coating is applied to each side in separate passes. Further, the present invention results in less or reduced scrap as compared to a multiple pass apparatus due to the fact that there is a reduced need for the seaming step in a continuous operation.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic illustration of the apparatus and process of the present invention.

### DETAILED DESCRIPTION OF THE INVENTION

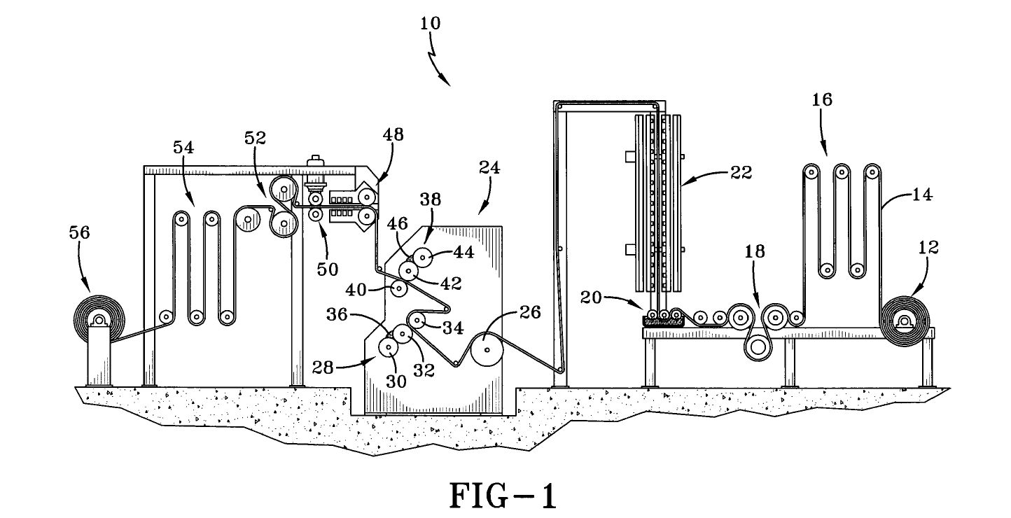

As shown in FIG. 1, the single or one-pass direct double lamination process and apparatus makes use of a dual calender line as part of the continuous coating process to laminate calendered thermoplastic and/or thermoset polymer coatings, such as polyurethane, polyolefin, polyvinylidene chloride, or polyvinylchloride (PVC) coatings on fabric substrates, such as nylon and polyester fabrics or yarns.

The laminate is basically a fabric base having a polymeric coating on each side of the fabric base. The fabric base provides the structural integrity and strength to the fabric while the polymeric coatings provide the protection and weatherability for the fabric. In one pass, a fabric having a calenderable coating on each side of the fabric can be achieved. If thicker coatings are desired, the fabric can be passed a second, third, or more times through for additional coatings. The process can be repeated until the desired thickness is achieved. Further, the process is versatile in that the coatings can be different on each side, including different colors, different polymeric materials, different additives, different compounds, and the like. For example, a first coating could provide opaqueness to the fabric and the second coating could provide a color or a function, such as reflectivity or infrared protection or the like.

The fabric, scrim, or web can be woven, knitted, or nonwoven. It can be an open weave or a closed weave. The fabric can be coated or uncoated. Further the fabric can comprise a wide range of multifilament or monofilament natural or synthetic fibers. The fibers can be polymeric materials, such as polyester, nylon, or polyolefin, e.g., polypropylene and polyethylene, glass fibers, synthetic fibers, natural fibers, or any appropriate fiber material. Polyester and nylon are preferred, and polyester has a favorable cost compared to the tensile and tear strength it possesses. The size of the yarns may vary from 5 denier to 2000 denier within different fabrics. Advantageously, the yarn size is around 1000 denier. This size allows the yarn to be strong enough to withstand the forces placed upon it, while being flexible enough to respond to any harsh bending the fabric may encounter. The yarns can also be individually coated to achieve certain properties.

The fabric is a unitary pre-manufactured nonwoven or woven structure, and would include weft inserted knits. The weight of the fabric may vary depending on the fabric's use. Where a more durable and weatherable fabric is needed, a heavier scrim and fabric may be more advantageous. Where external forces are less of a concern, a lighter scrim and fabric may be sufficient. In preferred embodiments, the weight of the fabric weight may range from 6-30 oz./yd².

The yarns within the fabric layer may bonded together, preferably by some type of adhesive. Adhesively bonding the warp and weft yarns together contributes integrity to the scrim. By not interlacing, interweaving, or interlocking the warp and weft yarns, the dimensional stability of the fabric is not diminished in the direction of the yarns because crimp is not added to the yarns. Crimp in the yarns, inherent in woven or knitted fabrics, causes less dimensional stability in the direction of the yarns. By having the yarns oriented in a straight line without any crimping, the fabric possesses increased stability in the direction of the yarns and the yarns have the ability to bear an increased load in that direction.

The outer coating layers may consist of a wide range of polymers, including thermoplastic polymers, thermoplastic elastomers, thermosetting polymers, and rubber compositions, especially those polymer compounds that can be calendared, but preferably the thermoplastic polymers and elastomers will be employed. Thus, any material which is capable of being calendered, including such thermoplastic materials as ABS, cellulose acetate, cellulose butyrate, cellulose propionate, ethylene/ethyl acrylate copolymers, alloys of PVC and acrylate ester polymers, chlorinated PVC, polyolefins, polyurethane and alloys of polyurethane, and so forth. The polymers can employ any of the conventional additives such as impact modifiers, stabilizers, lubricants, fillers, colorants, functional additives, and so on.

Specific thermoplastic materials covered by this invention include polyamides such as Elvamide 8062 (E. I. duPont), chlorinated polyolefins such as Alcryn (E. I. duPont), and a wide range of thermoplastic polyurethanes, including those based on polyethers, polyesters, polycarbonates or mixtures thereof. All these materials are non-reactive heat processable materials. Specific thermoplastic polyurethanes include the Estanes (B. F. Goodrich), Q-Thanes (K. J. Quinn) and Morthanes (Morton-Thiokol). Estane 5740 and 5788 are polycarbonate polyurethanes; Q-Thane PS-62 and Estane 58271 are typical polyester polyurethanes; and Q-Thane PE-88 is a typical polyether polyurethane. Blends of these polyurethanes are also suitable in the invention. For example, Morthane CA-1225 is a polyurethane formed by the reaction of an aliphatic polycarbonate and polytetramethylene glycol with an aromatic diisocyanate which is suitable for use in this invention.

Ethylene-α-olefin based copolymer rubbers, including polymer rubbers containing ethylene monomer unit and α-olefin monomer unit, and the olefin monomer unit as a main component can be employed. Examples of α-olefin which can be used include propylene, 1-butene, 1-pentene, 1-hexene, 4-methyl-1-pentene, 1-octene, 1-decene, etc. Thus, ethylene-propylene copolymer rubber (EPR) and ethylene-propylene-nonconjugated diene copolymer rubber (EPDM) can be used.

The characteristics of certain vinyl compounds, such as polyvinylidenefluoride (PVDF) or polyvinylchloride (PVC), make them ideal for use as the outer layers for bi-axial or multi-axial fabric. They possess flexibility, durability and the ability to repel water and fire, and are relatively inexpensive. For example, these vinyl compounds are more weatherable and flame resistant than commonly used polyethylene.

The outer layer will be applied on both sides of the scrim fabric. The outer layers can be bonded onto the scrim fabric. The outer layers contribute to the opaqueness, weatherability and the overall integrity of the fabric. Further, it may be desirable to apply different polymer films to each side of the fabric.

For example, this would be useful where one of the film has better properties, is more expensive than the other film, and only one of the sides is exposed to certain elemental conditions, such as sunlight or weather. Then, for example, the exposed side could be a urethane film, while the non-exposed side could be a vinyl polymer film. Other combinations are also possible such as making the coatings unbalanced by putting a heavier coating on one side than the others. This could be having the coating being the same material, but having the first coating be thicker than the second coating. Or, the coatings could be different compositions, but the same dimensionally. In that case, the coatings might have different densities so that one side has a heavier coating than the second side.

In the process, the fabric web is heated to raise its temperature, but also to drive off any residual moisture and/or solvents present on the surface of the film since the presence of these will affect the bonding of the coatings. Next, an adhesive may be applied to both sides of the fabric as part of the process or the fabric may be pre-coated, and so a pre-coated fabric fed as part of the process. In the apparatus shown in FIG. 1, a means for applying an adhesive coating is illustrated, but it is only optional and depends upon the coating to be achieved, as well as the materials employed. The adhesive may also function as an adhesion promoter for the coating to be subsequently applied.

If the fabric is an open weave scrim, for example, the polymer coating might be allowed to pass through the opening to achieve a thermoplastic bonding of the coating polymers. In the instance of an open weave web, the coatings pass through the web and achieve strike-through bonding or adhesion. This structure may be useful for certain applications. If the fabric is a closed weave, the use of an adhesion promoting coating may be desirable.

Next, the adhesive coated fabric is then joined to a first calendered film which is applied directly to the film, and bonded to the film by the use of a laminating roller. This is then followed by the application of a second calendered film, which is joined to the side of the film not yet coated and bonded to the film using a laminating roller to apply pressure to the laminate. Following the application of the second film, the laminate is cooled and collected.

As seen in FIG. 1, the process is shown generally at 10. A fabric 14 is fed from a roll 12 to an adhesive coating section 20 where the fabric 14 is coated with an adhesive. While the adhesive coating section is shown, the fabric could be a pre-coated fabric and the adhesive coating section and step would not be necessary. The fabric 14, as it is fed to the adhesive coating section 20, it passes through an accumulator section 16, which facilitates continuous feed of fabric 14 as the process slows and speeds up, as well as when it is necessary to change over of feed roll 12. As the fabric 14, which has now had the adhesive coated on it, enters the dual calender section 24, it will pass over a heater roll 26 which raises the temperature of the fabric 14 and facilitates bonding of the polymer coating.

The first polymer calendering section 28 includes a two roll calendar and conformable pressure roll, such as a rubber roll. As seen in FIG. 1, this consists of nip roller 34 for pressuring the fabric and the coating to promote bonding of the coating and the calendered film, and calender rolls 30 and 32. The application of the resin composition is achieved by depositing a controlled amount of the polymer resin at location 36 between calender roller 30 and calender roller 32 where it is formed into a melt calendered layer of polymer and then pressed onto the fabric substrate 14 as it passes between rollers 32 and 34. The nip pressure between the rollers is set to a value between about 50 pounds per linear inch (“pli”) and about 250 pli to facilitate the coating and the fabric layer 14 becoming laminated together.

The melt calendered layer can have a wide range of thickness depending on cost and performance capabilities desired. Typical thickness may range from a few mils (0.0031″) to very thick layers (0.050″ or greater). The thickness of the layer varies from less than 0.001 inch with a preferred variation of less than 0.0005 inch.

The coated fabric then passes to a second calendering station 38 which is made up of roller 44 and two calendering rollers 40 and 42. Again, the polymer compound 46 is fed into the nip between rollers 42 and 44 where it is formed into a melt calendered polymer layer which is then applied to the uncoated side of fabric 14 between rollers 40 and 42. The second calenderer is located subsequent to or down stream from the first calenderer, and in spaced apart relationship. The exact distance is not critical, but they are placed close enough to maintain the temperature of the first laminate or at least to not lose too much heat. Since the films have retained some of their heat, the apparatus can be run at a faster rate, as compared to the rate of an apparatus which needs two passes to apply the second coating. If needed, supplemental radiant heaters (not shown), but which are known in the art, can be employed at appropriate locations to between the heated rollers. Temperature sensors, which are known in the art, can be employed at various locations to provide a picture of the temperature profile of the coatings and the coated web to adjust the temperature based upon the operating and environmental (such as winter) conditions.

The laminate can be cooled by a combination of chill rolls 52 under pressure. The purpose of the cooling is to bring the resin from a molten to a rigid state with sufficient physical bonding to hold the structure in place. The product then passes through another accumulator 54 and taken off the line in a continuous manner and collected as a roll 56.

The winding or collection portion is typical and where the coated fabric is wound into a cylindrical coil and ready for shipment or the fabric can be slit to a prescribed width. Further, although not shown, but as is known in the art, a system can be employed that allows for a continuous feed of web by the use of multiple feed rollers which function in conjunction with the accumulator sections and allow for the switching from one feed roller to a second feed roller with the end of the first roll being sewn (or otherwise attached) to the leading edge of the second feed roll. At the collection end, multiple rollers can be employed there as well and these are used in conjunction with the accumulator section so that the collection can be shifted from one collection roller to a second collection roller while the apparatus continuously produces a double coated calendered laminate product in a single pass.

When desired, an embossed or textured coating can be achieved by passing the coated fabric between embossing rollers 50 prior to its final cooling step and before collecting the coated film.

In the present invention, melt calendering a melt processable layer directly to the textured substrate can be achieved without the air entrapment normally associated with lamination of a transparent layer onto an embossed or textured substrate by use of a conformable, preferably rubber, pressure roll.

For typical melt processable compositions, the specified viscosity range corresponds to a temperature range of 425° F. to 225° F. In this range the melt composition bonds well to the substrate and it flows to conform well to the embossed substrate while substantially maintaining a uniform thickness. The applied hot melt composition cools rapidly on the substrate avoiding distortion of the substrate resin though the melt temperature of the substrate may be similar to that of the hot melt composition which is applied.

The resulting coated fabric is useful in many coated fabric applications, especially fabrics coated on both sides. Examples of such uses include tents, tarps, fuel tanks, sign facing or billboards, inflatable boat fabric, architectural fabrics, single ply roofing membranes, geomembranes, and the like

Although the invention has been described in detail with reference to particular examples and embodiments, the examples and embodiments contained herein are merely illustrative and are not an exhaustive list. Variations and modifications of the present invention will readily occur to those skilled in the art. The present invention includes all such modifications and equivalents. The claims alone are intended to set forth the limits of the present invention.

What is claimed is:

1. An apparatus for forming a laminate of calendered films in one pass comprising:
A. Means for feeding a base fabric;
B. Heating means for preheating said fabric to raise the temperature of the fabric and remove residual moisture;
C. A first calendering means for forming a calendered film and applying said film to said base fabric;
D. Means for joining the first calendered film to said base fabric;
E. A second calendering means located subsequent to and spaced apart from the first calendering means for forming a second calendered film and applying said second film to the uncoated side of said base fabric;
F. Means for joining the second calendered film to said base fabric to form a double laminated film;
G. Means for cooling said double laminated film; and
H. Means for collecting said laminated film.

2. The apparatus of claim 1 wherein there is a further means for coating an adhesive on the base fabric on both sides of the fabric.

3. The apparatus of claim 1 wherein the calendering means consists of two calendering rollers.

4. The apparatus of claim 1 wherein said apparatus further has means for embossing said double laminated film.

5. A method of directly laminating a calendered film on both sides of a base web in one pass comprising the steps of:
A. Feeding a coated base fabric;
B. Preheating said fabric;
C. Applying a first calendered film to said base fabric;
D. Applying second calendered film to the uncoated side of said base fabric;
E. Cooling said double laminated film; and
F. Collecting said laminated film.

6. The process of claim 5 wherein the first and second calendered films are polyvinyl chloride, polyvinylidene chloride, or polyurethane.

7. The process of claim 5 wherein the calendering means is a two roll calender.

8. The process of claim 5 wherein said double laminated film is embossed prior to cooling and collecting said film.

9. The process of claim 5 wherein the fabric is a polyester or nylon fabric.

10. The process of claim 10 wherein the fabric is a woven, knitted or non-woven fabric.

11. The process of claim 5 wherein the calendered film has a thickness of between about 0.003 inch and 0.050 inch.
